(19) United States
(12) Patent Application Publication
(10) Pub. No.: US 2010/0020182 A1
(43) Pub. Date: Jan. 28, 2010

(54) PORTABLE ELECTRONIC DEVICE

(75) Inventors: Wen-Hung Wang, Taipei (TW); Tzu-Hao Fang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/486,772

(22) Filed: Jun. 18, 2009

(30) Foreign Application Priority Data
Jul. 23, 2008 (TW) 97127938

(51) Int. Cl. H04N 5/225

(52) U.S. Cl. 348/207.1; 348/E05.024

(57) ABSTRACT

A portable electronic device including a body, a control circuit, an object-image capture module, a first transmission mechanism and a receiver is provided. The control circuit is disposed in the body. The object-image capture module independent of the body includes a housing, an object-image capture circuit and a lens. The object-image capture circuit is disposed in the housing, and the lens is electrically connected to the control circuit by the object-image capture circuit. The first transmission mechanism includes a first shaft connected between the body and the object-image capture module. The receiver is electrically connected to the control circuit. The receiver is used to receive a signal and transmit the signal to the control circuit, such that the control circuit controls the first transmission mechanism to drive the object-image capture module to rotate about the first shaft.

### CROSS-REFERENCE TO RELATED APPLICATION

This application claims the priority benefit of Taiwan application serial no. 97127938, filed on Jul. 23, 2008. The entirety of the above-mentioned patent application is hereby incorporated by reference herein and made a part of specification.

### BACKGROUND OF THE INVENTION

1. Field of the Invention

The present invention generally relates to electronic devices, and more particularly, to a portable electronic device which is capable of automatically tracking a user.

2. Description of Related Art

The development in the internet and multimedia technology brings people far away from each other together. Users who get used to computers often use web cameras to talk to each other over a long distance, which we called “internet meeting”.

The web camera is typically placed on a table and the user at one end sits in front of a capture lens of the web camera. The capture lens is oriented in a particular direction to capture images. The user at an opposite end can only see the images within a capture range of the capture lens. However, during the internet meeting, the user often needs to move, for example, to an adjacent position to fetch a document. When the user moves out of the capture range of the capture lens, the user at the opposite end of the internet cannot see where the user at this one end is moving.

In order to allow the user at the opposite end to clearly know where the user at this one end is moving during the internet meeting, a majority of the current web cameras are quipped with a function of automatic tracking of the user.

The current web camera with the function of automatic tracking of the user tracks the user's movement by means of image processing. In short, when the user moves to another position to fetch a document or to a white board to make a presentation, the web camera uses image processing application to calculate the movement displacement and direction of the user and the image processing application drives the capture lens to move according to the calculation result.

However, using the image processing application to drive the capture lens to move needs time for calculation. When the user's hardware cannot meet the requirement of the calculation speed of the image processing application, at the time the image processing application needs for calculation may be very long which may lead to a lag. In addition, the capture lens is not driven by the image processing application to move until the calculation of the image processing application has calculated a result. As a result, the capture lens moves slowly which may not catch up with the user during the user's movement.

### SUMMARY OF THE INVENTION

Accordingly, the present invention is directed to a portable electronic device having an object-image capture module that is capable of automatically tracking a user.

The present invention provides a portable electronic device including a body, a control circuit, an object-image capture module, a first transmission mechanism, and a receiver. The control circuit is located in the body. The object-image capture module is independent of the body and includes a housing, an object-image capture circuit and a lens. The lens is located in the housing and electrically connected to the control circuit through the object-image capture circuit. The first transmission mechanism includes a first shaft connected between the body and the object-image capture module. The control circuit controls the first transmission mechanism to drive the object-image capture module to move. The receiver is electrically connected with the control circuit. The receiver is used to receive a signal and transmit the signal to the control circuit such that the control circuit controls the first transmission mechanism to drive the object-image capture module to rotate about the first shaft.

According to one embodiment of the present invention, the body is a notebook computer.

According to one embodiment of the present invention, the first transmission mechanism includes a direct current motor, a worm gear, a first bezel gear, and a second bezel gear. The direct current motor is located in the body. The worm gear is located in the body and connected with the direct current motor. The first bezel gear is located in the body and engaged with the worm gear. The second bezel gear is attached around the first shaft and engaged with the first bezel gear.

According to one embodiment of the present invention, the first transmission mechanism includes a stepped motor, a first gear, and a second gear. The stepper motor is located in the body. The first gear is located in the body and connected with the stepper motor. The second gear is attached around the first shaft and engaged with the first gear.

According to one embodiment of the present invention, the receiver is an optical sensor or a thermal sensor.

According to one embodiment of the present invention, the electronic device further includes a second transmission mechanism located in the housing. The second transmission mechanism includes a second shaft connected with the body and the object-image capture module. The control circuit controls the second transmission mechanism to drive the object-image capture module to move. The second shaft is perpendicular to the first shaft.

According to one embodiment of the present invention, the second transmission mechanism includes a direct current motor, a bezel gear set, the second shaft, and a worm gear. The direct current motor is located in the housing. The bezel gear set is connected with the direct current motor. The worm gear is attached around the second shaft and engaged with the bezel gear set.

According to one embodiment of the present invention, the second transmission mechanism includes a stepper motor and the second shaft. The stepper motor is located on the housing. The second shaft is connected with the stepper motor.

According to one embodiment of the present invention, the electronic device further includes a signal transmitter adapted to be equipped on an object whose image is to be captured by the object-image capture module.

In the portable electronic device, the object-image capture module can quickly rotate or move in a mechanical manner to track the user. In addition, upon receiving a signal at the receiver, the control circuit controls the first transmission mechanism and the second transmission mechanism to drive the object-image capture module to rotate so as to automatically track the object whose image is to be captured. In comparison with the existing object tracking system using the image processing technology, the object-image capture module of the portable electronic device of the present invention can more quickly capture the object image.

In order to make the aforementioned and other features and advantages of the present invention more comprehensible, embodiments accompanied with figures are described in detail below.

### BRIEF DESCRIPTION OF THE DRAWINGS

FIG. 1 illustrates a portable electronic device according to a first embodiment of the present invention.

FIG. 2 illustrates the object-image capture module and the body of FIG. 1.

FIG. 3 illustrates the first transmission mechanism of FIG. 1.

FIGS. 4A-4C illustrate automatic tracking of the user using the portable electronic device of the present embodiment where the user is in different positions, respectively.

FIG. 5 illustrates the portable electronic device of FIG. 1 that uses another first transmission mechanism.

FIG. 6 illustrates a portable electronic device according to a third embodiment of the present invention.

FIG. 7 illustrates the object-image capture module and second transmission mechanism of the portable electronic device of FIG. 6.

FIG. 8 illustrates the second transmission mechanism of FIG. 7.

FIG. 9 illustrates the portable electronic device of FIG. 6 using another second transmission mechanism.

FIG. 10 illustrates a portable electronic device according to a fifth embodiment of the present invention.

FIG. 11 illustrates the portable electronic device automatically track a user wearing a signal transmitter.

### DESCRIPTION OF THE EMBODIMENTS

### First Embodiment

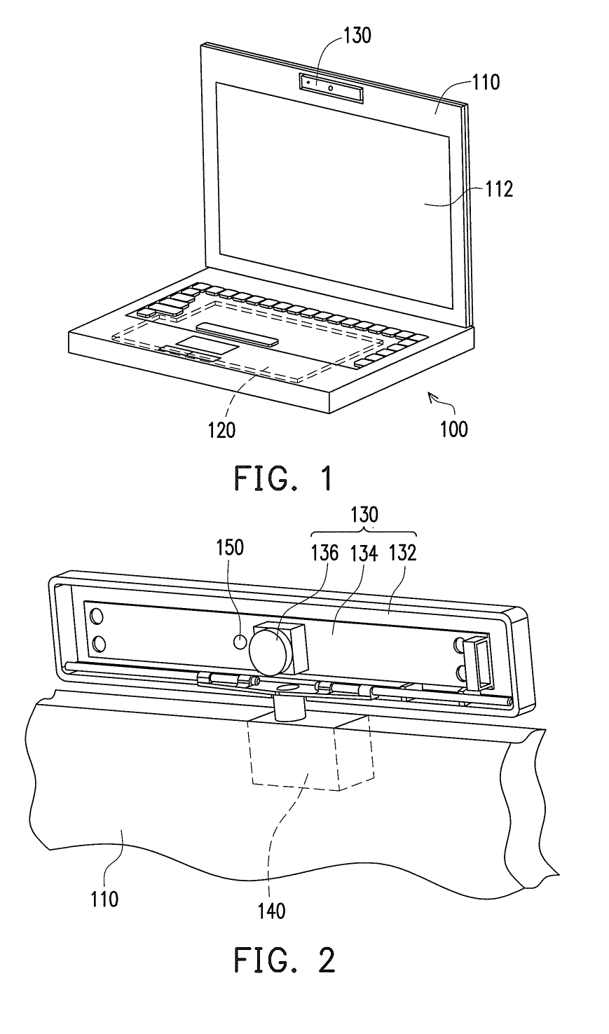

FIG. 1 illustrates a portable electronic device according to a first embodiment of the present invention. FIG. 2 illustrates the object-image capture module and the body of FIG. 1. Referring to FIGS. 1 and 2, the portable electronic device 100 includes a body 110, a control circuit 120, an object-image capture module 130, a first transmission mechanism 140, and a receiver 150. The body 110 is, for example, a notebook computer and includes a liquid crystal display 112. The control circuit 120 is disposed in the body 110 and electrically connected with the liquid crystal display 112.

The object-image capture module 130 independent of the body 110 is embedded into the body 110 and includes a housing 132, an object-image capture circuit 134, a base, and a lens 136. The object-image capture circuit 134 is electrically connected to the control circuit 120. The object-image capture circuit 134 and the base are both disposed in the housing 132. The lens 136 is electrically connected to the control circuit 120 through the object-image capture circuit 134.

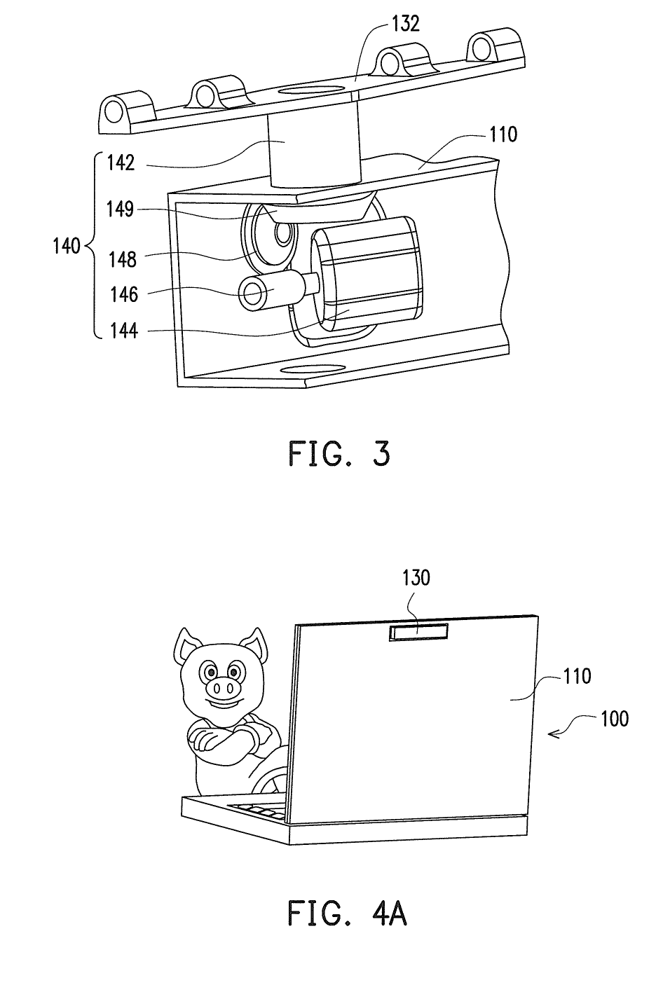

FIG. 3 illustrates the first transmission mechanism of FIG. 1. Referring to FIGS. 1-3, the first transmission mechanism 140 includes a first shaft 142, a direct current (DC) motor 144, a worm gear 146, a first bezel gear 148, and a second bezel gear 149. The first shaft 142 is connected between the body 110 and the object-image capture module 130. The DC motor 144 may be disposed in the body 110 and electrically connected with the control circuit 120. The worm gear 146 may be disposed in the body 110 and connected with the DC motor 144. The first bezel gear 148 may also be disposed in the body 110 and engaged with the worm gear 146. The second bezel gear 149 is attached around the first shaft 142 and engaged with the first bezel gear 148.

As shown in FIG. 1 and FIG. 2, the receiver 150 is disposed in the object-image capture module 130. For example, the receiver 150 may be embedded into the base. The receiver 150 is electrically connected to the control circuit 120. The receiver 150 is adapted to receive a signal and transmit the signal to the control circuit 120, such that the control circuit 120 controls the first transmission mechanism 140 to drive the object-image capture module 130 to rotate leftward or rightward about the first shaft 142 (shown in FIG. 3).

The receiver 150 of the present embodiment may be an optical sensor or a thermal sensor. When the receiver 150 is an optical sensor, the receiver 150 receives a signal indicative of a change in brightness of light to sense the user's movement. When the receiver 150 is a thermal sensor, the receiver 150 receives a signal indicative of a change in temperature. It is to be understood that the receiver 150 could be other types of sensors without departing from the scope of the present invention.

In addition, while the receiver 150 is disposed on the base of the object-image capture module 130 in the present embodiment, the receiver 150 may be disposed at any suitable location in the portable electronic device 100 depending upon actual requirements as long as the receiver 150 is able to sense the user's position, receive a signal and transmit the signal to the control circuit 120.

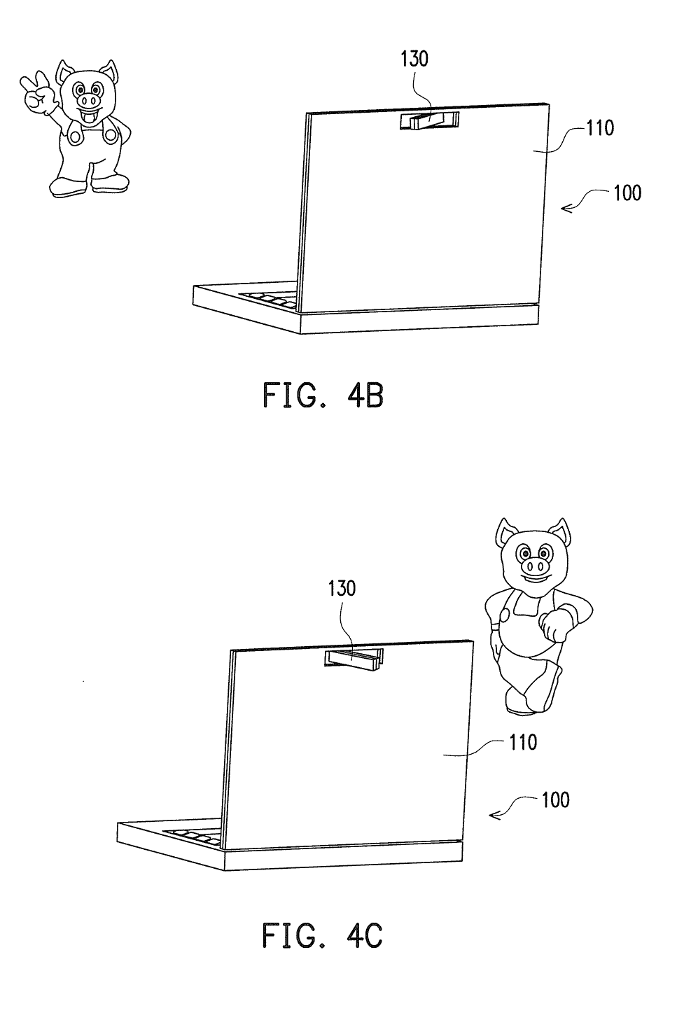

FIGS. 4A-4C illustrate automatic tracking of the user using the portable electronic device of the present embodiment where the user is in different positions, respectively. Referring to FIGS. 2, 3, and 4A, when the receiver 150 senses that the user is right in front of the portable electronic device 100, the control circuit 120 (as shown in FIG. 1) controls the first transmission mechanism 140 such that the object-image capture module 130 is oriented in a forward direction, which enables the lens 136 to capture the image of the user.

Referring to FIGS. 1, 3, and 4B, when the user moves from his or her original position to a position in left front of the liquid crystal display 112, the receiver 150 (shown in FIG. 2) senses the user's movement and transmits the signal to the control circuit 120. The control circuit 120 then controls the DC motor 144 to rotate which in turn drives the worm gear 146 to rotate. At this time, the first bezel gear 148 engaged with the worm gear 146 is rotated by the worm gear 146, and the second bezel gear 149 engaged with the first bezel gear 148 is rotated by the first bezel gear 148. Because the second bezel gear 149 is attached around the first shaft 142 and the first shaft 142 is connected with the housing 132 of the object-image capture module 130, the object-image capture module 130 is driven by the first transmission mechanism 140 to rotate about the first shaft 142 to the left of the liquid crystal display 112 so as to capture the user's image.

It is to be noted that the receiver 150 continuously senses the user's position and transmits the signals to the control circuit 120 and therefore the portable electronic device 100 keeps automatically tracking the user's position when the user keeps moving.

Referring then to FIGS. 1, 3 and 4C, when the user moves again, for example, to a position in right front of the liquid crystal display 112, in order to continuously capture the user's image, the receiver 150 (shown in FIG. 2) transmits the signal indicative of the user movement to the control circuit 120. The control circuit 120 then transmits the signal through the object-image capture circuit 134 to control the first transmission mechanism 140 to drive the object-image capture module 130 continuously rotate around the first shaft 142 to the right of the liquid crystal display 112 until the user stops moving.

As described above, the portable electronic device 100 of the present embodiment achieves quick movement and rotation of the object-image capture module in a mechanical manner. In addition, by using the receiver 150 to automatically track the user's movement, the information regarding the user's movement can be transmitted to the control circuit 120 once the receiver 150 receives a signal, and the control circuit 120 then controls the first transmission mechanism 140 to move the object-image capture module 130 to capture the user's image. In comparison with existing systems, the automatic tracking of the portable electronic device 100 of the present embodiment does not require calculation of image processing application thus reducing the time for waiting the calculation result. Thus, the automatic tracking of the portable electronic device 100 of the present embodiment can have a faster response speed to achieve a real-time capture of the user's image.

### Second Embodiment

The present embodiment is similar to the first embodiment in which like reference numerals indicate like components. The explanation of those same components is not repeated and below description is made only with regard to components that are different.

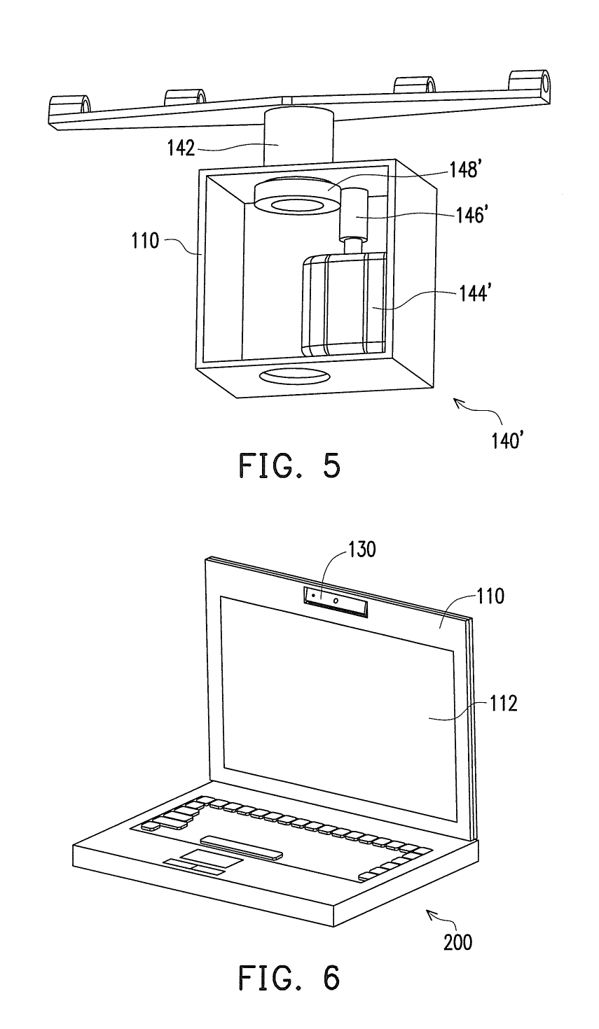

FIG. 5 illustrates the portable electronic device of FIG. 1 that uses another first transmission mechanism. Referring to FIG. 5, the first transmission mechanism 140′ of the present embodiment includes a first shaft 142, a stepper motor 144′, a first gear 146′, and a second gear 148′. The stepper motor 144′ and the first gear 146′ are disposed in the body 110. The first gear 146′ is connected with the stepper motor 144′. The second gear 148′ is also disposed in the body 110 and attached around the first shaft 142. The second gear 148′ is engaged with the first gear 146′.

When the user moves, the receiver 150 (shown in FIG. 2) receives a signal and transmits the signal to the control circuit 120 (shown in FIG. 1). The control circuit 120 then transmits the signal through the object-image capture circuit 134 to control the stepper motor 144′ to operate. At this time, the first gear 146′ engaged with the stepper motor 144′ begins to rotate and drives the second gear 148′ to rotate. As a result, the object-image capture module 130 (shown in FIG. 2) can rotate leftward or rightward about the first shaft 142 according to the user's movement.

### Third Embodiment

The present embodiment is similar to the first, second embodiments in which like reference numerals indicate like elements. Below description is made only with regard to the difference between the present embodiment and the first, second embodiments.

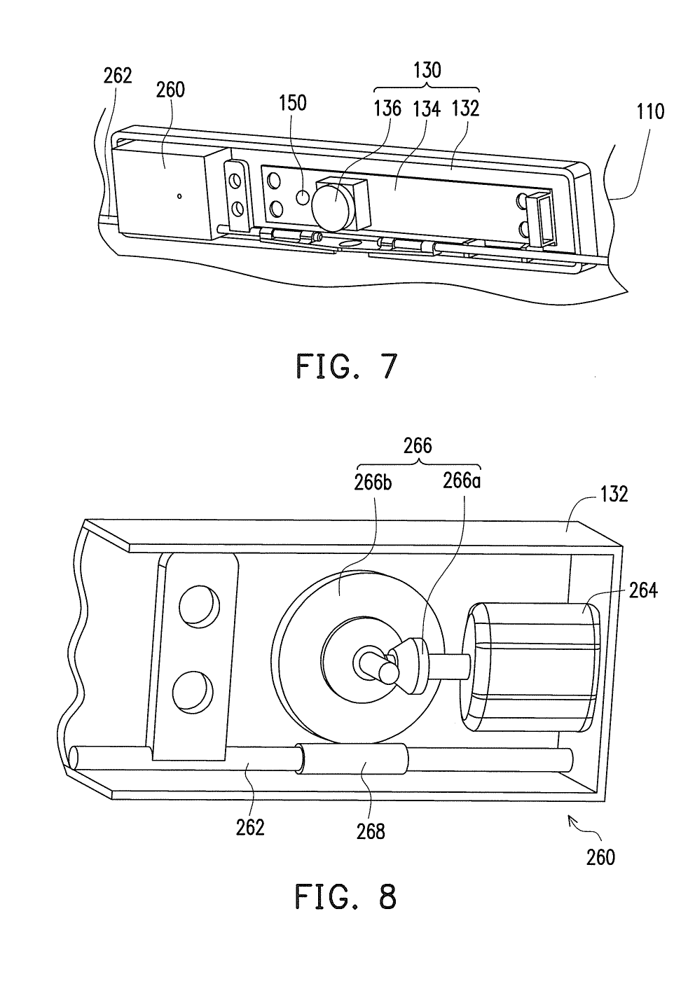

FIG. 6 illustrates a portable electronic device according to a third embodiment of the present invention, and FIG. 7 illustrates the object-image capture module and second transmission mechanism of the portable electronic device of FIG. 6. Referring to FIG. 6 and FIG. 7, different from the first and second embodiments, the portable electronic device 200 of the present embodiment employs a second transmission mechanism 260 to rotate the object-image capture module 130 upward or downward about a second shaft 262 of the second transmission mechanism 260. The second transmission mechanism 260 is disposed in the housing 132 adjacent to the lens 136. While the second transmission mechanism 260 is disposed in the housing 132 in the present embodiment, it is to be understood that the second transmission 260 could also be disposed in the body 110 without departing from the scope of the present invention.

FIG. 8 illustrates the second transmission mechanism of FIG. 7. Referring to FIGS. 7 and 8, specifically, the second transmission mechanism 260 includes a second shaft 262, a DC motor 264, a bezel gear set 266, and a worm gear 268. The second shaft 262 extends in the body 110 (shown in FIG. 6) and is connected with the housing 132. The DC motor 264 is disposed in the housing 132. The bezel gear set 266 has a first bezel gear 266a connected with the DC motor 264, and a second bezel gear 266b engaged with the first bezel gear 266a. The worm gear 268 is attached around the second shaft 262 and engaged with the second bezel gear 266b.

Similarly, when the receiver 150 of the portable electronic device 200 of the present embodiment receives a signal, the control circuit 120 (shown in FIG. 1) transmits the signal through the object-image capture circuit 134 to start the DC motor 264. The first bezel gear 266a drives the second bezel gear 266b to rotate which in turn drives the worm gear 26b to rotate. As a result, the housing 132 rotates about the second haft 262 upward or downward and the lens 136 rotates with the housing 132 to continuously capture the user's image.

### Fourth Embodiment

The present embodiment is similar to the third embodiment in which like elements are indicated by like reference numerals and explanation thereof is therefore not repeated.

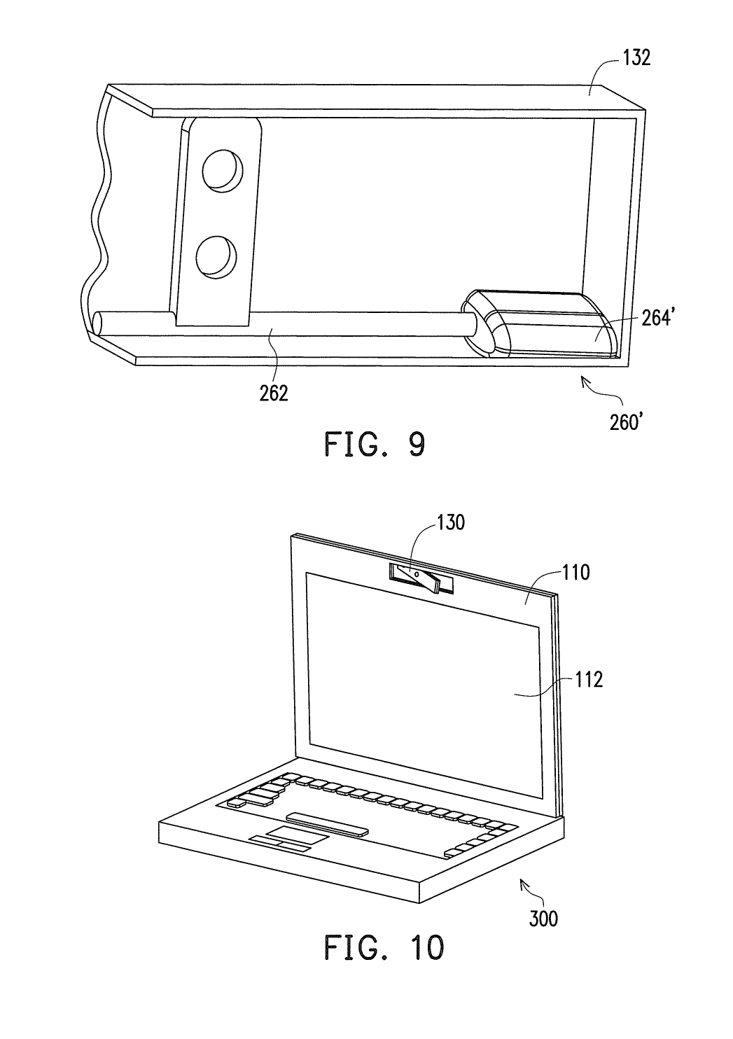

FIG. 9 illustrates the portable electronic device of FIG. 6 using another second transmission mechanism. Referring to FIG. 9, the second transmission mechanism 260′ of the present embodiment includes a stepper motor 264′ and a second shaft 262. The stepper motor 264′ is disposed on the housing 132. The second shaft 262 is fixedly mounted to the housing 132, extends in the body 110 (shown in FIG. 6), and is connected with the stepper motor 264′.

Similarly, when the receiver 150 (shown in FIG. 7) receives a signal, the control circuit 120 (shown in FIG. 1) transmits the signal through the object-image capture circuit 134 to start the stepper motor 264′ and the second shaft 262 rotates therewith. Because the second shaft 262 is fixedly mounted to the housing 132, the housing 132 rotates about the second shaft 262 upward or downward and the lens 136 (shown in FIG. 7) rotates with the housing 132 to continuously capture the user's image.

### Fifth Embodiment

FIG. 10 illustrates a portable electronic device according to a fifth embodiment of the present invention. Referring to FIG. 10, the portable electronic device 300 includes the first transmission mechanism 140 (shown in FIG. 3) or 140′ (shown in FIG. 5), and the second transmission mechanism 260 (shown in FIG. 8) or 260′ (shown in FIG. 9). As such, the object-image capture module 130 of the portable electronic device 300 of the present embodiment is capable of simultaneous rotations in two directions.

For example, when the user is above and on the left of the liquid crystal display 112, the object-image capture module 130 may rotate simultaneously leftward and upward. The first transmission mechanism 140 or 140′ and the second transmission mechanism 260 or 260′ have been described above with reference to FIG. 3, FIG. 5, FIG. 8 and FIG. 9, respectively, and, therefore, the explanation thereof is not repeated.

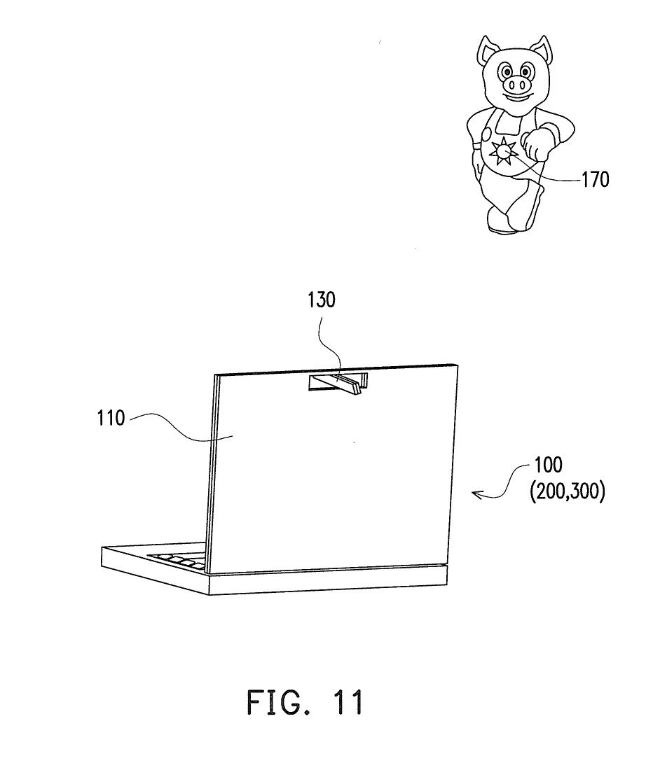

In particular, in order to enable the receiver 150 of the portable electronic devices 100, 200 and 300 to more quickly receive and recognize the signal, the user may further be equipped with a signal transmitter 170, as shown in FIG. 11. For ease of wearing, the signal transmitter 170 may be in the form of a badge or a proximity card. The use of the signal transmitter 170 not only can reduce the time for the receiver 150 to recognize the signal, but also can prevent the receiver 150 from receiving an incorrect signal, such that the portable electronic devices 100, 200 or 300 can more quickly automatically track the user.

In summary, the portable electronic device of the present invention has at least the following advantages:
1. Upon receiving a signal, the receiver directly transmits the signal to the control circuit. The control circuit then controls the transmission mechanism to drive the object-image capture module to track the user. Therefore, no calculation is required which results in a faster response speed, thereby achieving a real-time tracking of the user.
2. The use of the signal transmitter to transmit a signal not only provides a function of recognizing the user, but also enables the portable electronic device to more quickly automatically track the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic device comprising:
a body;
a control circuit located in the body;
an object-image capture module independently from the body, the module comprising a housing, an object-image capture circuit, and a lens, the lens located in the housing and electrically connected to the control circuit through the object-image capture circuit;
a first transmission mechanism comprising a first shaft connected with the body and the object-image capture module, the control circuit controlling the first transmission mechanism to drive the object-image capture module to move; and
a receiver electrically connected with the control circuit, the receiver adapted to receive a signal and transmit the signal to the control circuit such that the control circuit controls the first transmission mechanism to drive the object-image capture module to rotate about the first shaft.

2. The portable electronic device according to claim 1, wherein the portable electronic device is a notebook computer.

3. The portable electronic device according to claim 1, wherein the first transmission mechanism comprises:
a direct current motor located in the body;
a worm gear located in the body and connected with the direct current motor;
a first bezel gear located in the body and engaged with the worm gear; and
a second bezel gear attached around the first shaft and engaged with the first bezel gear.

4. The portable electronic device according to claim 1, wherein the first transmission mechanism comprises:
a stepper motor located in the body;
a first gear located in the body and connected with the stepper motor; and
a second gear attached around the first shaft and engaged with the first gear.

5. The portable electronic device according to claim 1, wherein the receiver comprises an optical sensor or a thermal sensor.

6. The portable electronic device according to claim 1, further comprising a second transmission mechanism located in the housing, wherein the second transmission mechanism comprises a second shaft connected with the body and the object-image capture module, the control circuit controls the second transmission mechanism to drive the object-image capture module to move, and the second shaft is perpendicular to the first shaft.

7. The portable electronic device according to claim 6, wherein the second transmission mechanism comprises:
a direct current motor located in the housing;
a bezel gear set connected with the direct current motor;
the second shaft; and
a worm gear attached around the second shaft and engaged with the bezel gear set.

8. The portable electronic device according to claim 6, wherein the second transmission mechanism comprises:
a stepper motor located on the housing; and
the second shaft connected with the stepper motor.

9. The portable electronic device according to claim 1, further comprising a signal transmitter adapted to be equipped on an object whose image is to be captured by the object-image capture module.
